(19) United States
(12) Patent Application Publication
(10) Pub. No.: US 2011/0234591 A1
(43) Pub. Date: Sep. 29, 2011

(54) Personalized Apparel and Accessories Inventory and Display

(75) Inventors: Pragyana Mishra, Kirkland, WA (US); Nishant Dani, Redmond, WA (US); Cole Brooking, Kirkland, WA (US); Pengpeng Wang, Redmond, WA (US); Manjula A. Iyer, Kirkland, WA (US)

(73) Assignee: MICROSOFT CORPORATION, Redmond, WA (US)

(21) Appl. No.: 12/732,971

(22) Filed: Mar. 26, 2010

(51) Int. Cl. G06T 15/50; G06F 3/048; G06Q 30/00

(52) U.S. Cl. 345/426; 715/851; 715/739; 705/27.1

(57) ABSTRACT

Viewing apparel in a store or a catalog may not show a purchaser how the item will look in different light or settings. A user may select elements of a scene, such as a setting, a mannequin, a pose for the mannequin, and apparel/accessories from a web browser-based application. The selected elements are processed by a hierarchy of services that first divide the scene into component elements, render each element, and return the result to a composition server that combines and flattens the renderings into a 2D image. The 2D image is viewable on any platform or browser without the need for special graphics hardware.

### RELATED APPLICATION

This application is a related to U.S. patent application Ser. No. 12/652,351, titled “Automated Generation of Garment Construction Specification,” filed on Jan. 5, 2010, which is hereby incorporated by reference for all purposes.

### BACKGROUND

On-line shopping for commodity items such as books and tools can be accomplished with little anxiety about whether the item will be suitable after delivery to the consumer. However, personal items are not in that category of safe purchases, with concerns about color, texture, and fit not addressed until the item is delivered. 3D modeling has been proposed as a solution to such concerns, for example, for previewing the fit and drape of clothing. But such modeling requires complex and data-intense processing on even high-end platforms, particularly for netbook and handheld devices.

### SUMMARY

A system for displaying 3D objects uses a hierarchy of computing platforms to divide and process three dimensional (3D) model data before rendering final images for display on simple user devices including, but not limited to netbooks, mobile phones, gaming devices, laptop and desktop computers, using only an out-of-the-box web browser. Different backgrounds and lighting conditions are supported, and in the case of clothing, different styles of clothing as well as fabric type, color, and patterns can be simulated on an animated mannequins. Unlike slower ray-tracing rendering used in feature films, the 3D images can be calculated, rendered, and delivered at frame rates at or near full motion video even on limited function viewing platforms.

Once rendered, the final still frames or animations can be delivered to multiple platforms, allowing users to share an experience, such as apparel and accessory selection.

The mannequins may be selected from a palette of mannequins representing different body styles or may be customized to a person's exact measurements. Modeling the physics of a fabric allow the motion of the mannequin to present a user with the fit, flow, and drape of a garment over a body in motion from different viewing positions and in different lighting conditions. A more complete discussion of this process is available in the above-referenced patent application.

As opposed to shopping in a mall environment, a user of the system can view an apparel item in an appropriate setting and lighting condition, such as a swimsuit at the beach in bright sun or an evening gown worn at a ballroom under dimmed lights. Additionally, a user can view apparel items from a retailer in combination with other garments or accessories already owned by the user or available from another retailer.

In the case of clothing, a virtual closet of clothes and accessories may be built for use in mix and match planning with clothing already owned or contemplated for purchase. A virtual clothing environment also allows a person to mix and match apparel and accessories with friends and family.

The technique is also applicable to other 3D modeling applications, such as furniture in a room, window dressings, interior/exterior colors on an automobile, etc., where lighting, fabric/surface characteristics, viewing angle, and background play a role in overall perception.

### BRIEF DESCRIPTION OF THE DRAWINGS

FIG. 1 is a block diagram of an exemplary computing device;

FIG. 2 is a illustrates a representative operational architecture;

FIG. 3 is a block diagram of a hierarchy supporting personalized apparel and accessories inventory and display;

FIG. 4 is block diagram illustrating another hierarchy supporting personalized apparel and accessories inventory and display;

FIG. 5 is block diagram illustrating yet another hierarchy supporting personalized apparel and accessories inventory and display;

FIG. 6 is a flow chart of a method of developing and displaying personalized apparel; and

FIG. 7 is an exemplary image resulting from an exemplary embodiment.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘_’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

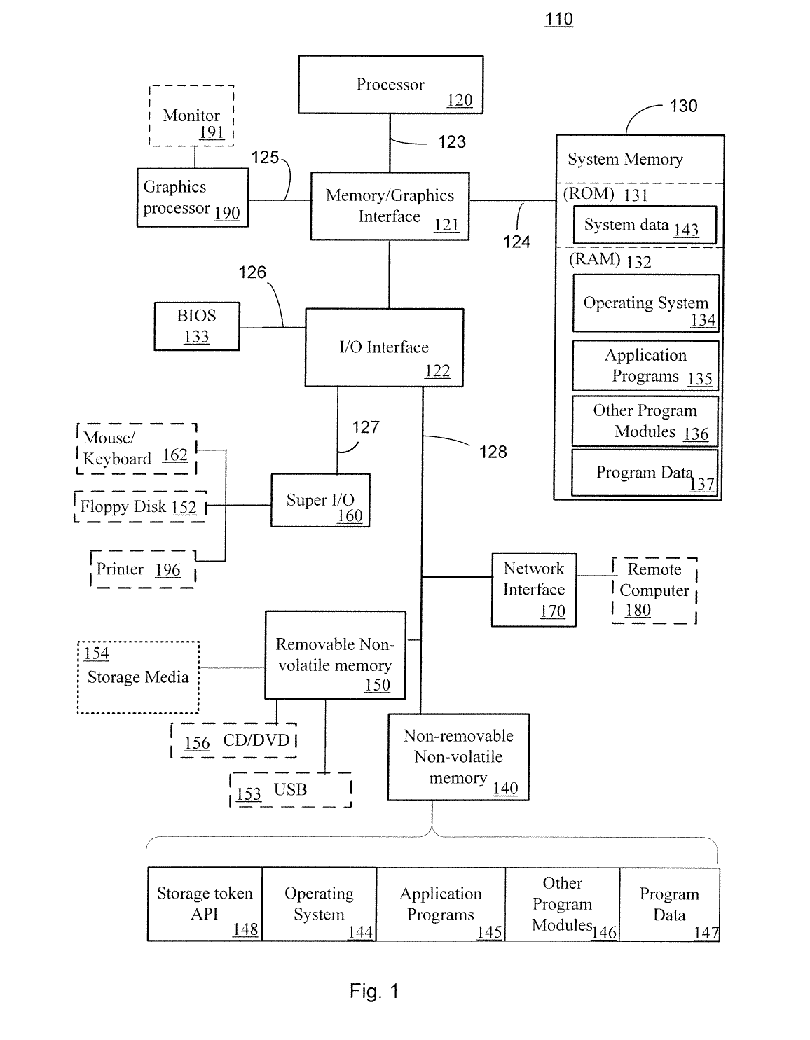

With reference to FIG. 1, an exemplary computing device for implementing the claimed method and apparatus includes a general purpose computing device in the form of a computer 110. Components shown in dashed outline are not technically part of the computer 110, but are used to illustrate the exemplary embodiment of FIG. 1. The hardware components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport™ architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise a computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as floppy disk 152, keyboard/mouse 162, and printer 196, as examples. The super I/O chip 160 may be connected to the I/O interface 122 with a bus 127, such as a low pin count (LPC) bus, in some embodiments. Various embodiments of the super I/O chip 160 are widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

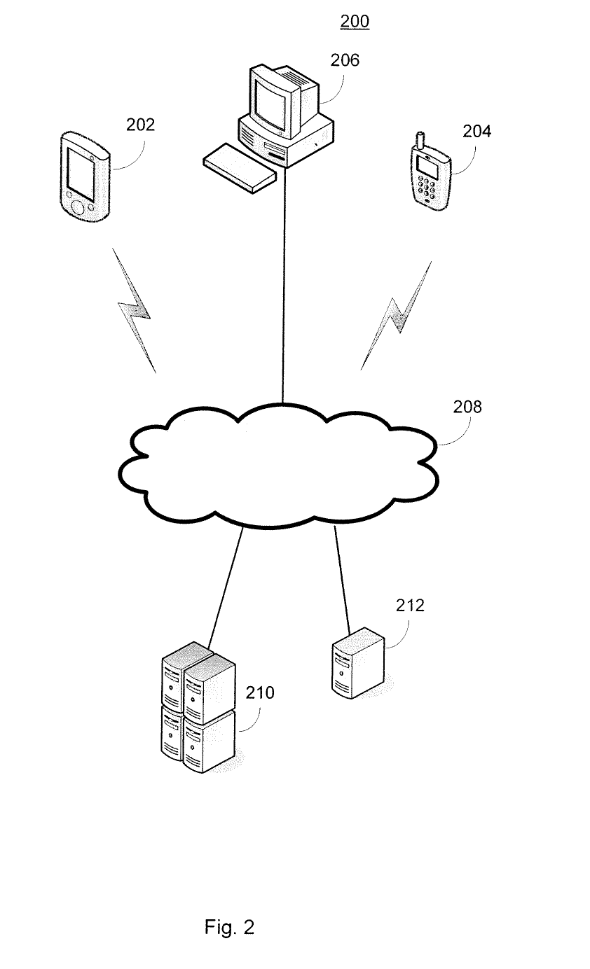

The computer 110 may also include other removable/non-removable, volatile/nonvolatile computer storage media. By way of example only, FIG. 1 illustrates a hard disk drive 140 that reads from or writes to non-removable, nonvolatile magnetic media. The hard disk drive 140 may be a conventional hard disk drive or may be similar to the storage media described below with respect to FIG. 2.

Removable media, such as a universal serial bus (USB) memory 153, firewire (IEEE 1394), or CD/DVD drive 156 may be connected to the PCI bus 128 directly or through an interface 150. A storage media 154 similar to that described below with respect to FIG. 2 may coupled through interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processor 120 through one of the I/O interface busses, such as the SPI bus 126, the LPC bus 127, or the PCI bus 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include other networks. Such networking environments are commonplace in offices, enterprise-wide computer networks, intranets, and the Internet. The remote computer 180 may also represent a web server supporting interactive sessions with the computer 110.

In some embodiments, the network interface may use a modem (not depicted) when a broadband connection is not available or is not used. It will be appreciated that the network connection shown is exemplary and other means of establishing a communications link between the computers may be used.

FIG. 2 illustrates a block diagram 200 of a representative operational architecture for use in presenting personalized apparel and accessories. A number of representative client devices, including, but not limited to, a tablet 202, a smart phone 204 and a personal computer 206 may be used to select a scene and display results. The tablet 202 and the smart phone 204 are illustrated as having wireless connections, while the personal computer 206 is illustrated as having a wired connection. Of course, any combination of networking technologies may apply to different embodiments of the architecture.

As used herein, the term scene is defined to mean a collection of viewable elements and conditions used in created a final rendered image. The collection may include a set or setting, such as an office, an entertainment venue, a beach, a street, etc. The collection may also include a mannequin and pose. The mannequin may be selected from a palette of mannequins to match a users general body measurements or the mannequin may be generated from a given set of body measurements. The collection may also include one or more apparel items and accessories, for example, a dress, skirt and top, pants, shirt, necklace, bracelet, belt, shoes, etc. The collection may further include a light type or lighting condition, such as, but not limited to, sunny, bright, dim, afternoon, fluorescent, etc., and a camera view, that is, a point from which to generate the image.

FIG. 2 also illustrates a network 208, such as the Internet, an intranet, or local area network. The network 208 may connect the representative client devices 202, 204, 206 to one or more processing resources or servers 210 and 212.

In operation, a client device, such as the smart phone 204 may initiate a browsing session to select and display a scene. The scene information may be transmitted using predefined references, such as set 2, pose 4, apparel 10 (for example, from a personal closet), camera view orthogonal distances as x-coordinate, y-coordinate, z-coordinate, corresponding to a location relative to a center of the selected set. The request may be carried over the network 208 to a first tier of processing that separates the scene into component elements. The component elements may be further processed at the same or different servers available via the network 208. Renderings of the component elements are returned to a server for combination back into the scene and may be flattened to a 2D image for transmission back to the smart phone 204, where the image may be displayed.

The selected scene may include animation information that is used to generate a series of requests that are processed in real time or near real time so that an animated sequence may be presented on the smart phone 204. The animated sequence allows a user to view, for example, the drape, flow, and color of the selected apparel as it would appear not just in one pose but in motion. The process is discussed in more detail below.

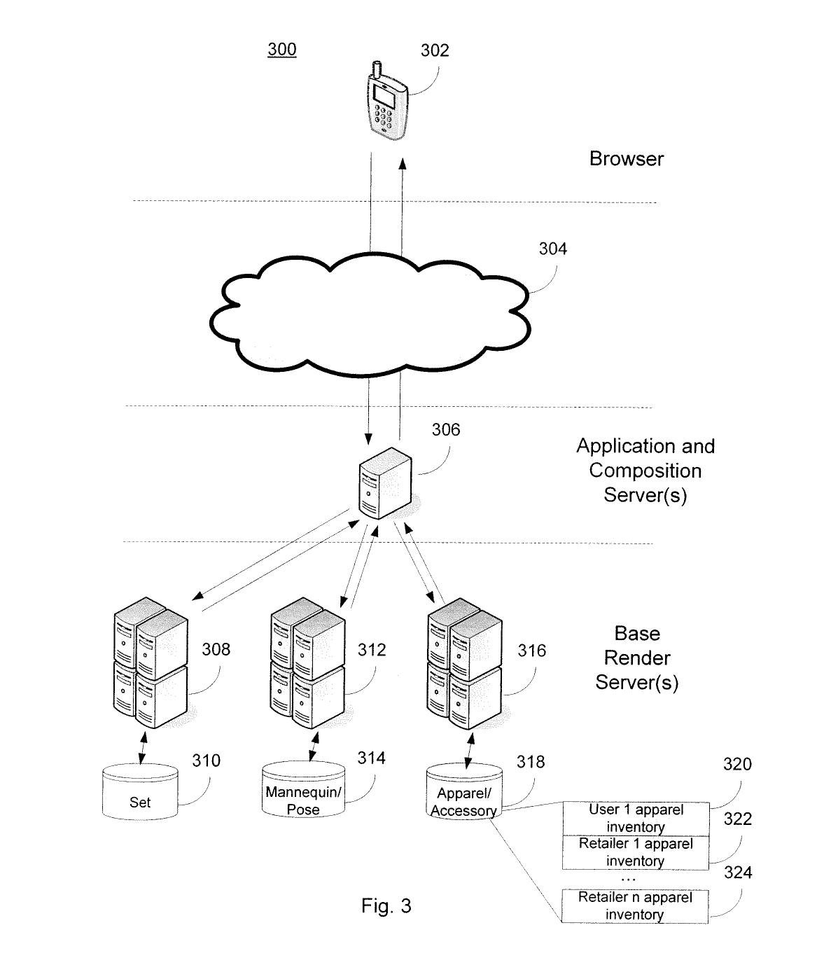

FIG. 3, is a block diagram 300 of a hierarchy supporting personalized apparel and accessories inventory and display.

In the exemplary embodiment of FIG. 3, a smart phone 302 is connected via a network 304 to a composition server 306. The composition server 306 may support two general functions, an application service supporting a webpage, and a composition service that distributes rendering jobs and combines rendering results. The composition server 306 may serve the webpage to the smart phone 302 that allows a user to select a scene, mannequin, apparel, and related options for display.

At a logical tier below the application and composition server 306 or servers, may be individual base render servers. For example, a server 308 may be used to render a selected set. The server 308 may use a database 310 of predetermined set types. Another exemplary server 312 may be used to render a mannequin and pose selected from a mannequin/pose database 314. Yet another exemplary server 316 may be used to render a garment and accessories, selected from a corresponding apparel and accessory database 318. The composition and base render servers are particular examples of processing resources that may be used to calculate desired results. Other examples of processing resources may be dedicated processors of a multi-processor computer or separate processes running on a single computer or server.

The apparel and accessory database 318 may include separate tables, or similar representations, of a particular user's apparel inventory 320 and one or more retailer of apparel inventories 322, 324. Additional user apparel inventories (not depicted) may be accessible to a particular user given the correct permissions.

As illustrated in FIG. 3, an application/composition server 306 may be distinct and separate from the individual base rendering servers 308, 312, and 316. Each server, 306, 308, 312, 316 may support dedicated services corresponding to the individual functions supported by that server. For example, the set server 308 may support a set service that runs on the server 308 according to computer executable instructions stored on computer readable media associated with server 308. Similarly, the mannequin/pose server 312 and the apparel/accessories server 316 may each support corresponding services implemented by computer executable instructions stored on their respective computer readable media.

The depiction of the hierarchical embodiment of FIG. 3 should not be used to construe or limit that the connections between the application server or servers and the base render servers cannot also be through network 304.

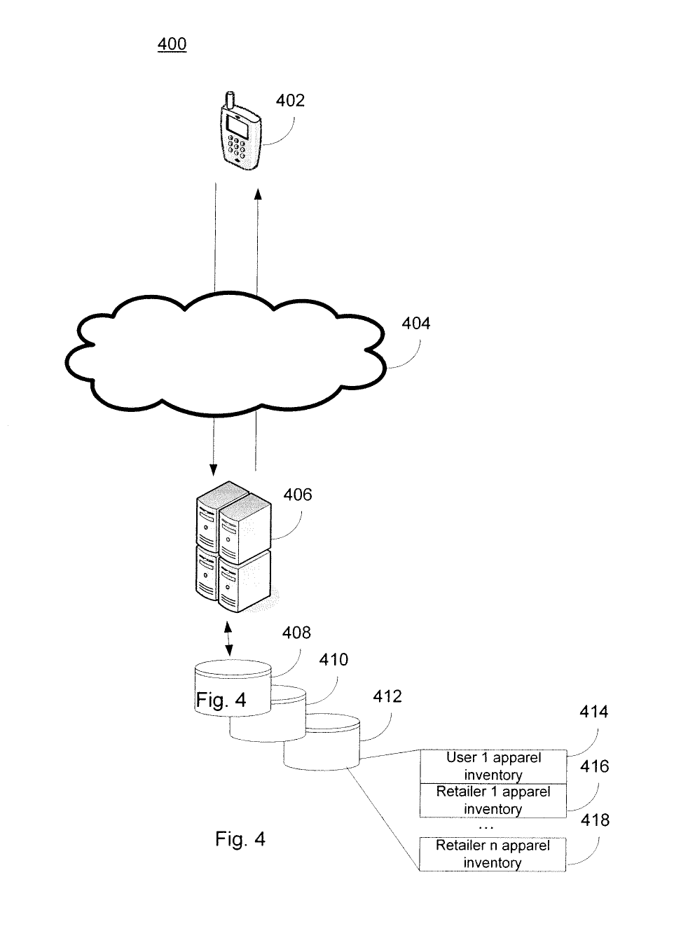

FIG. 4 is another block diagram 400 that illustrates another system architecture supporting personalized apparel and accessories inventory and display. In this exemplary embodiment, a representative user device, shown as a smart phone 402 may connect via a network 404 with a single server 406 or server farm (not depicted). One or more databases, illustrated as databases 408, 410, 412 may contain, together or separately, the exemplary set, mannequin/pose, and apparel/accessories databases.

In the exemplary embodiment of FIG. 4, the various services discussed with respect to FIG. 3 above, for example, the composition service, the application service, the set service, the mannequin/pose service, and the apparel/accessories service, may each be hosted on the server 406. As depicted above with respect to FIG. 3, a variety of apparel databases 414, 416, 418 may be stored on one or more of the databases 408, 410, 412.

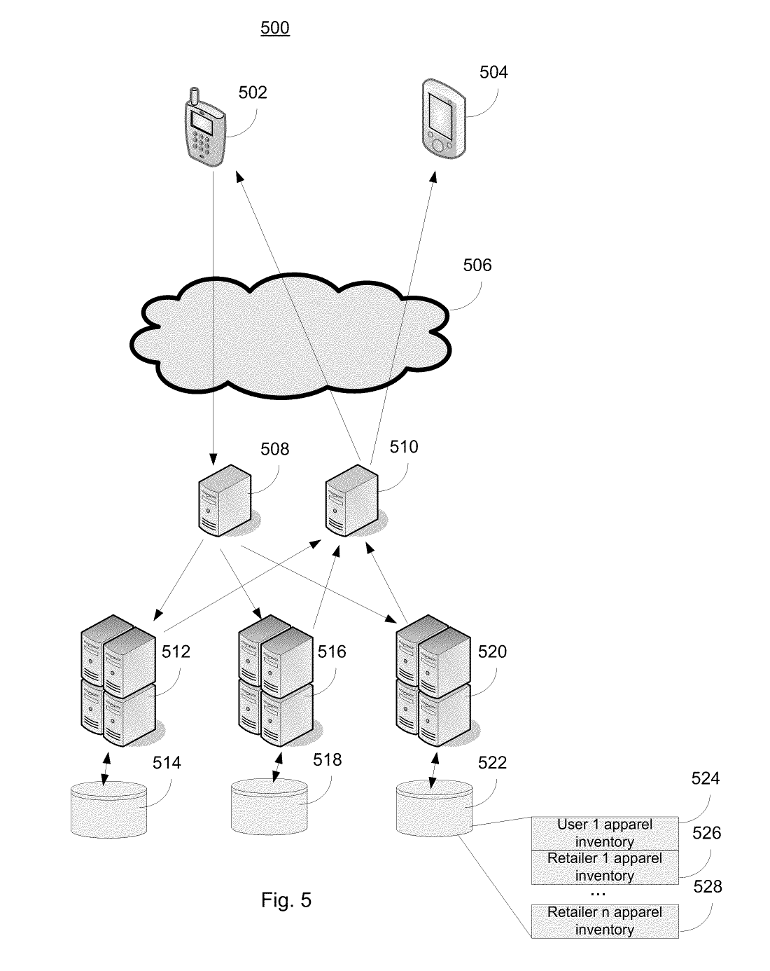

FIG. 5 is a block diagram 500 that illustrates yet another exemplary system architecture supporting personalized apparel and accessories inventory and display. A representative user device, shown as smart phone 502 may use a webpage served by an application server 508 to create a selection of set, mannequin, pose, apparel and accessories, light type, and camera view that described a particular scene.

As discussed below, the application server may split the scene data received via network 506 into sets of data used to render a particular element of the scene. For example, a set server 512, using set descriptive data from set database 514 may render the set using the user selected set, light type, and camera view information. A mannequin/pose server 516, using mannequin/pose database 518, may render a selected mannequin in a selected pose according to the user selected mannequin, pose, light, and camera view information. An apparel/accessories server 520 may access an apparel and accessory database 522 that may include one or more user and retailer apparel inventories, for example user apparel inventory 524, a first retailer apparel inventory 526, and another retailer apparel inventory 528. The apparel/accessories server 520 may use the database 522 to render the apparel and accessories selected by the user in view of the selected light type and camera view.

In this exemplary embodiment, the rendered outputs from each of the servers 512, 516, 520 may be returned to the composition server 510 for combining and flattening from three dimensions (3D) to two dimensions (2D). The composition server 510 may then send the final image to a browser on the smart phone 502 for viewing by the user. Alternatively, or in addition to, sending the image to the smart phone 502, the image may be sent to another device, such as tablet 504, for viewing. The exemplary second device, tablet 504, may provide a higher resolution display or may be used by another person with whom the original user wishes to share a view the final image.

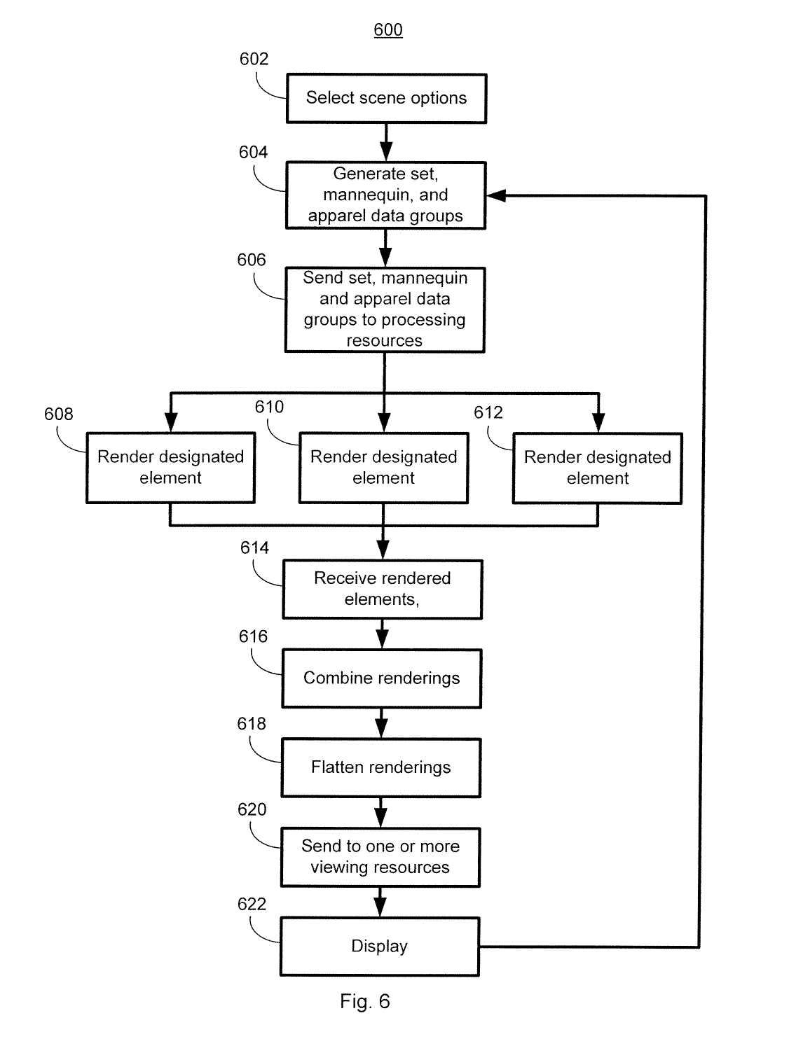

FIG. 6 is a flow chart of a method 600 of developing and displaying personalized apparel. At block 602, various scene options may be collected. The scene options may include a set, that is, a room or outdoor environment, a mannequin, a pose of the mannequin, apparel and optionally accessories, light type, and a camera view. The light type may include brightness and source information, such as, bright or dim, florescent lighting, incandescent lighting, sunlight, etc. The apparel may be selected from a retailer provided selection of apparel. Alternatively, the apparel may be from an inventory of articles either owned or contemplated by a particular user. The apparel may be a garment, such as but not limited to pants, shirt, dress, etc., and may include accessories such as but not limited to shoes, jewelry, scarves, hats, gloves, etc.

The scene options may be presented to a user via web browser hosted by a web page supported by an application server, such as application server 508, or by an application/composition server, such as application/composition server 306. The web browser may also collect inputs from the user related to the scene options, such a set, a mannequin, a pose of the mannequin, apparel, accessories (if any), light type, camera view, etc. The camera view may be expressed relative to the set as a side displacement (x), a front-to-back displacement (y), and a vertical or height displacement (z) from an initial position of the mannequin on the set.

The same web browser used to collect scene inputs may also be used as a viewing resource for the display of the image resulting from the rendering processes, although more than one browser window can be dedicated to the scene input collection and the viewing resource. In some embodiments, such as when another user is invited to share a view or animation, the two functions may be supported on different browsers on different platforms.

Optionally, in one embodiment, animation inputs may also be collected with the scene information. Animation inputs may be selected from a predetermined track or may be traced using the web browser. The animation inputs may include route and body motions selected to show the color response, drape, and flow of a item of apparel for the given set and lighting conditions.

At block 604, after the scene inputs are collected at an application/composition server 306, different groups of data may be generated. A first data group including the set, the light type, and the camera view may be generated. A second data group including the mannequin, the pose, the light type, and the camera view may be generated. And a third data group including the apparel, the light type, and the camera view may also be generated. The scene inputs may include metadata as well, such as the pixel dimensions and color depth of the end viewing area, so that the remaining steps can tailor their respective outputs to the target viewing area and capability.

At block 606, the first, second, and third data groups may be sent to the respective set server 308, mannequin/pose server 312, and apparel/accessories server 316 by the application/composition server 306.

At block 608, the set processing resource 608 may generate a first base rendering of the set from the first data group. At block 610, the mannequin/pose server 312 may generate a second base rendering of the mannequin at a given pose, which may include a displacement position from an initial position, from the second data group. At block 612, the apparel/accessories server 316 may generate a third base rendering of the apparel and any accessories from the third data group. Rendering involves determining a color for each pixel in the viewing frame. Numerous rendering techniques are known and applicable, such as various forms of scanline rendering or pixel-by-pixel rendering. Rather than attempting to render both moving and stationary elements in the same pass, in this embodiment, elements are sorted and rendered by their type. That is, the stationary set, the moving mannequin with a relatively constant surface, and the cloth of the apparel, which may have folds or color changes based on light angle, are all calculated separately on different processing resources. Mannequin and set images may create reflections in elements of the set. These reflections may also be calculated during the respective mannequin and apparel base rendering processes.

At block 614, the separate base first base rendering of the set, the second base rendering of the mannequin, and the third base rendering of the apparel may be sent to a composition processing resource. The composition processing resource may be the same process that collected the scene inputs at block 604, but may be different.

At block 616, the composition processing resource may generate a composite rendering including the first, second, and third base renderings. The composite rendering may be accomplished by simply overlaying the three renderings. Reflections and overlaps may be accommodated by setting different levels of transparency for any element through which another element may be seen.

At block 618, the combined rendering may be flattened, that is, the 3D rendering may be projected onto a 2D surface and the rendered 2D image captured.

At block 620, the flattened, composite 2D image may be sent to a viewing resource. The viewing resource may be a handheld device or other display-capable computing platform. At block 622, the viewing resource may display the composite 2D image, for example, using a web browser. In other embodiments, the image may be delivered to more than one viewing resource for joint viewing by more than one user.

When an animation sequence is selected, as described above with respect to block 602, the process may return to block 604 where a next frame of the animation is queued and the activities of blocks 604 through 622 may be repeated. The process may be repeated in real time with respect to a frame rate of displaying the composite 2D image at the viewing resource, so that minimal or no buffering in the viewing resource is required. Because not buffering kept to an absolute minimum, for example, one frame, the viewing resource may have only minimal memory and associated memory management capabilities. Because the images arrive already flattened and, optionally, sized to a display area, complex image processing at the viewing resource is minimized or eliminated, unlike a dedicated gaming system or high end computer, although those machines can also be used as viewing resources.

Because the animation process is built to the ‘weakest link,’ that is, a low function graphics display and the more compute intensive processes are offloaded and, optionally, distributed, partial animation of greater than 3 frames per second may be supported, while in some cases, full motion animation of 10-30 frames per second may be achieved.

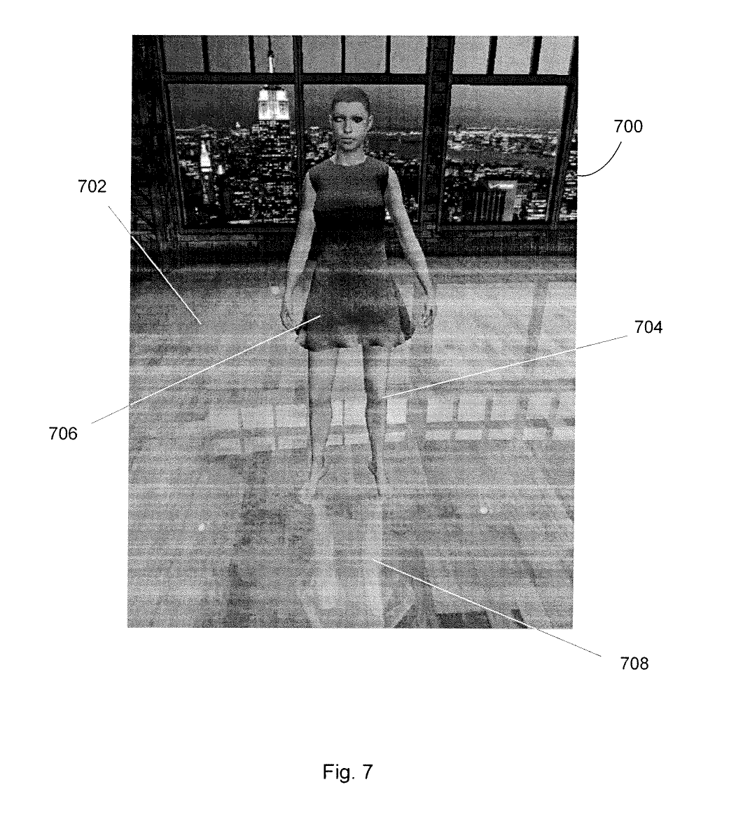

FIG. 7 is a black and white depiction of a composite 2D image 700, such as that described above. The image 700 illustrates a set 702, a mannequin 704, and an apparel item 706. The bottom of the apparel item 706 shows the change in color due to the light angle on the folds. A reflection 708 illustrates a rendering of the image showing a semi-transparent region of the image overlaid on the floor of the set 702. In other cases, such as minors, an overlaid region may be fully transparent, that is not visible so that another object can be projected onto that spot.

The ability to capture complex scene information, divided among a number of services and or services on different servers, allows complex, customized animations to be requested and viewed from a very simple platform such as a common web browser. The ability to generate data sets with overlapping information, such as lighting type and camera view, which are then separately rendered and later combined allows a speed improvement over ray-tracing algorithms of several orders of magnitude. This speed improvement enables users with very simple platforms, such as smart phones, to create customized full-motion animations in real time. When applied to a shopping situation the user benefits from being able to view a selected item of apparel or accessory in a variety of settings and lighting conditions as well as from different angles or ‘camera views.’ A retailer, particularly an online retailer, benefits from being able to present a user with a more complete understanding of an item contemplated for purchase as well as being able to suggest complementary accessories for different types of use.

The same technology may be easily applied to related online shopping experiences. For example, customized rooms may be furnished with online 3-D models of furniture and appliances for viewing in a variety of lighting conditions and from a variety of angles, using even simple platforms such as smart phones.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of presenting a virtual environment including a mannequin with apparel comprising:
determining a scene including a set, the mannequin, a pose, the apparel, a light type, and a camera view;
(i) generating a first data group including the set, the light type, and the camera view;
generating a second data group including the mannequin, the pose, the light type, and the camera view;
generating a third data group including the apparel, the light type, and the camera view;
sending the first data group to a set processing resource;
generating a first base rendering of the set at the set processing resource;
sending the second data group to a mannequin processing resource;
generating a second base rendering of the mannequin at the mannequin processing resource;
sending the third data group to an apparel processing resource;
generating a third base rendering of the apparel at the apparel processing resource;
sending each of the first, second, and third base renderings to a composition resource;
generating a composite rendering including the first, the second, and the third base renderings at the composition resource;
sending the composite rendering to a viewing resource; and
(ii) displaying the composite rendering at the viewing resource.

2. The method of claim 1, further comprising:
selecting an animation sequence corresponding to motion of the mannequin and the apparel in the set; and
repeating steps (i) through (ii) for each additional composite rendering generated in the animation sequence.

3. The method of claim 2, wherein steps (i) through (ii) occur in real time with respect to a frame rate of the displaying the composite rendering at the viewing resource.

4. The method of claim 2, wherein the viewing resource provides a selected mannequin animation sequence.

5. The method of claim 1, wherein generating the first base rendering of the set includes setting a region to transparent where the region is obscured by another element.

6. The method of claim 1, further comprising receiving a selection of the set, the mannequin, the pose, the apparel, the light type, and the camera view from the viewing resource.

7. The method of claim 1, further comprising selecting the apparel from a retailer-provided selection of an available apparel.

8. The method of claim 1, wherein the apparel is a garment and includes an accessory.

9. The method of claim 1, wherein the viewing resource is a handheld electronic device.

10. The method of claim 1, wherein the viewing resource uses a web browser for displaying the composite rendering.

11. A system for processing of 3D animations comprising:
a composition server having a first computer storage media storing a first executable program that is executed on the composition server to cause the composition server to process inputs that determine a set, a 3D model, a pose, an apparel, a lighting condition and a camera view;
a set server having a second computer storage media storing a second executable program that is executed on the set server to receive the set, the lighting condition, and the camera view from the composition server to cause the set to be rendered for the lighting condition and the camera view;
a 3D model server having a third computer storage media storing a third executable program that is executed on the 3D model server to receive the 3D model, the pose, the lighting condition, and the camera view from the composition server to cause 3D model to be rendered for the lighting condition and the camera view;
an apparel server having a fourth computer storage media storing a fourth executable program that is executed on the apparel server to cause the apparel to be rendered for the lighting condition and the camera view;
the composition server storing a fifth executable program that is executed on the composition server to cause renderings from the set, the 3D model, and apparel servers to be overlaid and rendered to a 2D image for display by a display resource.

12. The system of claim 11, wherein the composition server receives requests for updated rendered 2D images and provides corresponding rendered 2D images at a rate of at least 10 frames per second.

13. The system of claim 11, further comprising a set database, a 3D model and pose database, and an apparel and accessory database.

14. The system of claim 11, wherein the display resource is a web browser.

15. The system of claim 11, wherein the composition server decomposes a requested scene into the set, the 3D model and the pose, and lighting and camera views for distribution to the set server, the 3D model server, and the apparel servers.

16. A system for real-time processing of 3D animations implemented by at least one computer using computer executable instructions implementing programs stored on at least one computer readable media, the system comprising:
a composition service implemented by a first executable program that processes input data to determine a set, a mannequin, a pose, an apparel, a lighting condition, and a camera view;
a set service implemented by a second executable program that receives the set, the lighting condition, and the camera view from the composition service and renders the set for the lighting condition and the camera view;
a mannequin service implemented by a third executable program that receives the mannequin, the pose, the lighting condition, and the camera view from the composition service and renders the mannequin for the lighting condition and the camera view;
an apparel service implemented by a fourth executable program that receives the apparel, the lighting condition, and the camera view from the composition service and renders the apparel for the lighting condition and the camera view;
wherein the composition service further programmed to receive a rendered set, a rendered mannequin, and a rendered apparel from their respective services and to render a 2D image from the rendered set, the rendered mannequin, and the rendered apparel for display by a display resource.

17. The system of claim 16, further comprising a user interface service used by the display resource for queuing requests for 2D images at a frame rate of at least 3 frames per second.

18. The system of claim 17, wherein the user interface service receives a selection of the set, the 3D model, the pose, the lighting condition, and the camera view.

19. The system of claim 18, wherein the camera view is described by an orthogonal x, y, and z distance offset from a point of the set corresponding to an initial mannequin position on the set.

20. The system of claim 16, wherein the composition service, the set service, the mannequin service, the apparel service, and the display resource are hosted on separate computers connected by a network.
